(19) United States
(12) Patent Application Publication
(10) Pub. No.: US 2026/0218430 A1
(43) Pub. Date: Jul. 30, 2026

(54) TUFTED MATERIAL

(71) Applicant: Ruggable LLC, Gardena, CA (US)

(72) Inventors: Lydia Wei-Ju Chen, Lakewood, CA (US); Therese Mona-Lisa Germain, Los Angeles, CA (US); Jordan David Marzouk, Santa Monica, CA (US)

(73) Assignee: Ruggable LLC, Gardena, CA (US)

(21) Appl. No.: 19/143,381

(22) PCT Filed: Dec. 20, 2023
(86) PCT No.: PCT/US2023/085228

§ 371 Date: Jun. 26, 2025

Related U.S. Application Data
(60) Provisional application No. 63/477,222, filed on Dec. 27, 2022.

(51) Int. Cl. D05C 17/02; D06N 7/00

(52) U.S. Cl. CPC D05C 17/026; D06N 7/0065; D05D 2209/10; D06N 2201/02; D10B 2331/10; D10B 2401/02; D10B 2403/0111; D10B 2503/04

(57) ABSTRACT

A machine-washable tufted material that is configured to aesthetically appear to be a wool includes a top layer, a liquid barrier layer, and a bottom layer. The top layer includes a base material and a plurality of yarns that are tufted to the base material. The yarns are treated to be directionalized in an upward direction and have a pile height in a range of 2 mm to 13 mm with a density of 63 GSM to 117 GSM.

### BACKGROUND

### Technical Field

This disclosure relates to a tufted material that may be used for various applications, including incorporation into household goods such as rugs and other floor coverings.

### Background Art

Many rugs make use of tufted material, an example of which is shown in FIG. 1. With reference to the figure, the tufted material 100 comprises a backing surface 110 (which can be made of fabric, netting material, combination of the same or other material) into which yarns 120 are stitched. The yarns 120 protrude from the backing surface to form a top surface 130 upon which a person would step. In general, the collection of yarns 120 form the pile of the material, and the height 140 of the yarns can be referred to as the pile height of the material. The characteristics of the yarn, the pile height, and the backing surface can play a significant role in the foot feel of the tufted material 100. The use of thick and dense yarns with high piles in tufted rugs can lend a plush feeling to the rug, which may be a desired feature for consumers. Such thicker and dense yarns with higher piles often include stiff or otherwise dense backing surfaces to support the increased pile.

Tufted rugs can be harder to clean than thinner or non-tufted rugs. For example, the yarns can make the rug too heavy or large to fit into standard household or home washers and/or dryers. The use of stiff backing surfaces and/or the presence of additional layers of material underneath the tufted layer (e.g., latex or rubber adhesives, water barrier layers, padding, or non-slip backings) can further decrease the malleability, flexibility, product longevity, and cleanability or washability of many tufted rugs.

Additionally, thick piles and stiff backing surfaces may allow rolling in only one direction without damage. Further, these rugs often cannot be folded or crumpled up, making them unable to fit into household or home washers and/or dryers. Thus, some such rugs, though at times advertised as being “machine washable,” cannot actually be washed using traditional residential machines. Rather, often, so-called “machine washable” rugs must actually be taken to a laundromat with larger commercial washing machines. In practice, then, inconvenience may cause consumers to wash these rugs infrequently.

Many existing tufted rugs use wool yarns to form the tufted pile. However, wool yarns can be difficult to maintain. For example, wool yarns can be prone to shedding. Wool yarns can be odorous when wet. Even new wool rugs may be odorous and may become more pungent when wet. Also, the layers in wool rugs can be held together with latex or rubber-based adhesive which may off-gas. Some consumers may find such characteristics to be undesirable. As such, some consumers may prefer to avoid using animal products, including wool.

Other existing tufted rugs use synthetic yarns designed to replace and perhaps look like wool. However, some of these synthetic yarns have a “dry” and rough feel or may have an unnatural shine that does not look like real wool.

Many tufted rugs have surface yarns that are tufted into a stiff base, such as a non-woven or woven base made of polypropylene, nylon, polyester, or similar material. The use of the stiff base can exacerbate an uncomfortable foot feel. The stiff base may also crack, crumble into powder, retain stains, mold, and/or deteriorate over time. Also, especially in tufted rugs that are not intended to be machine washable, the yarns may be tufted into the base material using relatively weak tuft binding, where surface yarns and layers are held together with a latex adhesive that further stiffens the rug and may delaminate and lose flatness over time. This can result in the yarns falling out or matted surface yarns over time. Thus, durability may be lacking in some existing tufted rugs.

Some existing tufted rugs can present safety concerns. For example, tufted rugs can be flammable. To reduce flammability, some manufacturers apply fire retardant chemicals to tufted rugs. Some of these fire retardant chemicals may be harmful to the environment and/or hazardous to human health. These fire-retardant chemicals may also lose effectiveness if the rugs are washed multiple times.

Some existing tufted rugs do not employ a rug pad. These rugs may undesirably slide around on the floor, especially when used on relatively smooth floors such as wood, tile, or stone.

### SUMMARY

This application is directed to tufted materials that avoid some or all of the downsides of existing tufted materials.

The present disclosure is directed to a tufted multi-layer material that may be incorporated into household goods such as rugs, floor coverings or other applications. In some embodiments, the tufted material has a comfortable foot feel, is durable, and has characteristics that allow for cleaning using traditional household washing machines.

### BRIEF DESCRIPTION OF THE DRAWINGS

Various aspects of the present disclosure are described hereinbelow with reference to the drawings, which are not necessarily drawn to scale, which are incorporated in and constitute a part of this specification.

FIG. 1 shows a side view of a prior art tufted rug.

FIG. 2 is a perspective view of an exemplary tufted material comprising a stack of layers according to embodiments of the present disclosure.

FIG. 3 is a side view of the stack of FIG. 2.

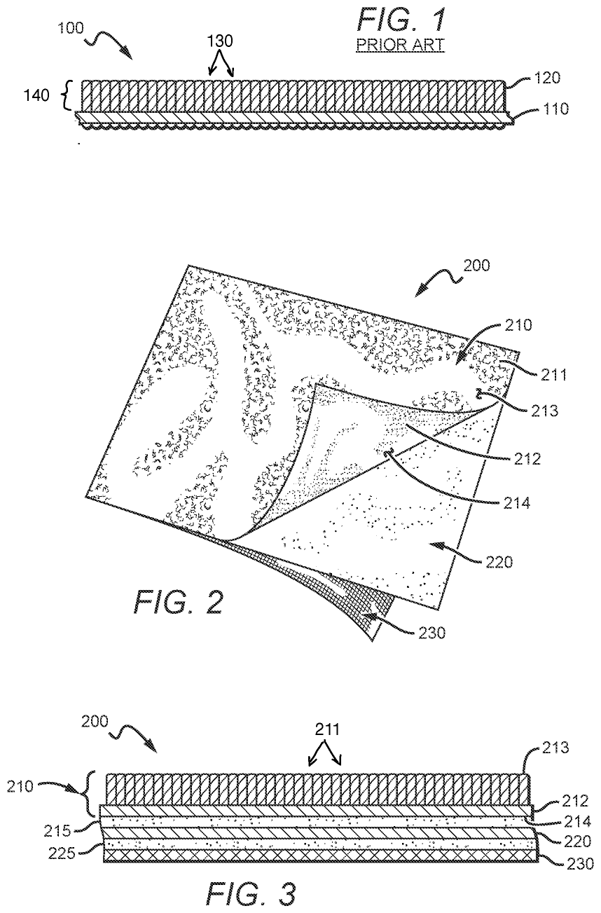

### DETAILED DESCRIPTION

Disclosed is a tufted material that can be used in household or commercial applications, such as to make rugs, floor mats, or other floor coverings.

### Terms

The terms listed below each include their plain and ordinary meaning known to a person of skill in the art, which includes at least the provided information.

“Denier” is a unit of measurement for the linear mass density of fibers, and means the mass in grams per 9,000 meters of the fiber.

“GSM” means grams per square meter (g/m²).

“Pile” means the raised surface of a fabric, usually including upright loops or strands of yarn.

### Stack Layers

FIGS. 2 and 3 show the tufted material 200 as a stack of layered materials provided in accordance with embodiments of the present disclosure. In various embodiments, the layered materials comprise three layers as follows:
A first material layer 210 provides the tufted pile for the overall tufted material 200, as well as the base structure for the tufted pile. The height of the pile is measured from a top of a base material 212 to a top surface 213 of the first material layer 210. The first material layer 210 may comprise yarns tufted into the base material 212 formed of a non-woven spunlace polyester fabric.
A second material layer 220 provides a liquid barrier that prevents, for example, spills or stains from penetrating through the stack of materials. The second material layer may comprise a thermoplastic polyurethane.
A third material layer 230 may be configured to attach to a pad or to rest on another surface, such as flooring. The third material layer 230 may comprise a knit backing.

In some embodiments, the layers of material 210, 220, 230 may be bonded to each other using various means including adhesive as follows:
A hot melt adhesive 215 may bond the first material layer 210 to the second material layer 220.
A hot melt adhesive 225 may bond the second material layer 220 to the third material layer 230.

These layers 210, 220, 230 are described in more detail below. It would be appreciated by a skilled artisan from the disclosure herein that embodiments or implementations may arrange the layers in a different order, use a different material for a particular layer, use additional or fewer layers, have liquid resistant layers that reduce rather than eliminate liquid passthrough, or make other changes, all without departing from the scope of this disclosure.

### First Material Layer: Tufted Pile Surface

As shown in FIGS. 2 and 3, the first material layer 210 of the tufted material 200 comprises yarns 211 tufted into a base material 212. In some embodiments, the first material layer 210 contributes significantly to the feel of the overall material 200 as the top surface 213 of the first material layer 210 is the outer facing portion of the material 200. Attention to and careful selection of materials including yarns is consistent with this layer being the most often touched by a person. For instance, in a rug made of the tufted material 200, this first material layer 210 would provide the top surface that would be felt by a person.

In embodiments, the yarns 211 mimic the look and feel of natural wool. The yarns 211 may be a yarn with a low-luster finish so that it does not exhibit a shine that presents an artificial aesthetic.

In some embodiments, the tufting process sends the yarns 211 through the base material 212 so that the yarns 211 stick out from the base material 212 in a generally perpendicular direction.

The base material 212 is a material that mechanically binds the yarns 211 such that the yarns 211 stick out from the base material 212. The base material 212 may be washable and may be flexible. The base material 212 may be suitable for exposure to high heat, e.g., 200 degrees Celsius, while supporting the yarns 211 such that the base material 212 is capable of being exposed to heat without burning or melting. The base material 212 may remain dimensionally stable, flexible, and/or reduce shrinkage in a range of temperatures, e.g., 0 degrees Celsius to 220 degrees Celsius. In some embodiments, the base material remain dimensionally stable, flexible, and/or reduce shrinkage in a range of temperatures in a temperature range of 185 degrees Celsius to 220 degrees Celsius, e.g., in a range of 195 degrees Celsius to 210 degrees Celsius. In embodiments, the base material 212 may be flexible such that the tufted material 200 may be capable of being placed in a home or residential washing machine for cleaning while supporting the yarns 211 with minimal shedding.

The base material 212 may be a nonwoven material. The base material 212 may be a nonwoven formed of a variety of methods including needle punching or hydrojetting such that fibers of the nonwoven fabric are entangled to form a flexible nonwoven fabric. For example, the base material 212 may be a spunlace nonwoven fabric. A spunlace nonwoven is a fabric that is formed by carding, dry laying, or wet laying fibers and hydrojetting the fibers to entangle the fibers to form a flexible web of entangled fibers. After hydrojetting, the entangled fibers may be dried and rolled. The web of fibers may be heat treated to form thermal bonds between the entangled fibers. The spunlace nonwoven fabric may form a strong and flexible fabric.

The base material 212 may be formed of a variety of materials including, but not limited to, cotton fibers, polyester fibers, nylon fibers, acrylic fibers, modacrylic fibers, polyethylene terephthalate (PET) fibers, or other synthetic fibers. In some embodiments, the base material 212 may include polyester fibers that form a spunlace nonwoven fabric.

In embodiments, the base material 212 is formed of a plurality of fibers that are entangled as described above. In some embodiments, the fibers are 1.5 inches or less in length. In certain embodiments, the base material 212 is formed of long fibers or a single fiber that is/are entangled to form the base material 212. When the fibers are long, the fibers may have an average length greater than or equal to 4 inches, e.g., 5, 6, 7, 8, 9, or 10 inches. In particular embodiments, the fibers may have an average length greater than 10 inches or be the entire base material 212 may be formed of a single continuous fiber. When long or single continuous fibers are used, the fibers of the base material may be synthetic fibers. The fibers may have a longitudinal or tensile breaking strength of 280 N per 5 cm to 360 N per 5 cm, e.g., 320 N per 5 cm. The fibers may have a weft breaking strength of 250 N per 5 cm to 310 N per 5 cm, e.g., 280 N per 5 cm.

The base material or fabric woven from the fibers may have a thickness of 0.4 mm to 1 mm, e.g., 0.6 mm. The weight of the base material 212 may be in the range of 63 GSM to 117 GSM. In some embodiments, the weight of the base material 212 may be in the range of 85.5 GSM to 94.5 GSM, such as 90 GSM.

After the tufting process, the bottom 214 of the base material 212 may be sprayed with an adhesive so as to help maintain the stability of the yarns 211. In some embodiments, the adhesive may be a water-based flame-resistant adhesive. In certain embodiments, the adhesive may be a mixture of 55% vinyl acetate ethylene and 45% water. This mixture may provide flame resistance through multiple wash and dry cycles without the use of hazardous flame retardant chemicals, e.g., 10 launderings. The weight of the adhesive may be in the range of 126 GSM to 234 GSM, such as 180 GSM.

In embodiments, the yarns 211 are densely packed to provide a comfortable and luxurious hand feel. In some embodiments, the yarns 211 have an even or uniform pile height throughout, which may be achieved, e.g., by applying sharp hook cutters across the top surface 213 after the yarns 211 are tufted into the base material 212. The density of the yarns 211 and the evenness of top surface 213 may make the first material layer 210 more amenable to surface treatments, such as the application of colors or other design elements or protective sealants.

In furtherance of the objective of making the first material layer 210, and thus the overall tufted material 200, comfortable to the touch yet amenable to surface treatments, the pile height of the yarns 211, as measured from the top of the base material 212 to the top surface 213, may be in the range of 2 mm to 13 mm. In certain embodiments, the pile height of the yarns 211 may be in the range of 5 mm to 7 mm, such as 6 mm. The linear mass density of the yarns 211 may be in the range of 1,500 to 6,000 denier, such as 3,000 denier. The density of the yarns 211 as packed together may be in the range of 680 GSM to 960 GSM, such as 800 GSM.

Although disclosed with specific reference to materials and manufacturing processes, an artisan will recognize from the disclosure herein different embodiments with different or alternative materials and/or manufacturing processes that accomplish the look and feel of wool yarns using synthetic materials. For example, materials such as acrylic, modacrylic, polypropylene, rayon, recycled polyester, or nylon may be used instead of or in junction with the above. An artisan will recognize from the disclosure herein different embodiments with different or alternative materials and/or manufacturing processes for the base material 212. For example, the base material 212 may be a woven material or a rubber-like material.

### Second Material Layer: Liquid Barrier

The second material layer 220 shown in FIGS. 2 and 3 comprises a sheet of material that prevents or at least reduces liquids, including water, from seeping through the stack. The second material layer 220 may be omitted in some embodiments, particularly if liquid resistance is not needed for a particular intended product of the tufted material 200. In some embodiments, the second material layer 220 should be thick enough to prevent seepage but thin enough to allow the overall tufted material 200 to maintain flexibility. In some embodiments, the second material layer 220 may comprise a 15 GSM thermoplastic polyurethane (TPU), though it is possible to use a TPU of other weights or a different material altogether.

Although disclosed with specific reference to polyurethane, an artisan will recognize from the disclosure herein different or alternative liquid resistant or liquid barrier layers. For example, it is possible to lend a degree of liquid resistance to fabric by the application of spill-resistant coatings. Some of these coatings, such as PFAS chemicals, may include chemicals that can cause health concerns or that are banned, restricted, or may become banned in countries including the United States.

### Third Material Layer: Base

The third material layer 230 may be the bottom layer of the stack. The third material layer 230 may comprise a knit loop material of polyester yarn (e.g., of 50 denier and 120 GSM) designed to removably attach to a rug pad (not shown) comprising hook material, such as described in U.S. Pat. No. 8,309,198. In embodiments, the third material layer 230 may comprise hook material or a loop material with the rug pad including the other of a hook material or a loop material.

In certain embodiments, the third material layer 230 may itself comprise a rug pad, or one or more additional layers may be placed or adhered below the third material layer 230 to provide a rug pad. In some embodiments, the third material layer 230 is configured to contact the floor or ground.

Although disclosed with specific reference to materials and manufacturing processes, an artisan will recognize from the disclosure herein different embodiments with different or alternative materials and/or manufacturing processes for the base layer. For example, materials such as velvet, fleece, felt, and TPE may be used instead of or in junction with the above.

Although disclosed with specific reference to materials and manufacturing processes, an artisan will recognize from the disclosure herein different embodiments with different or alternative materials and/or manufacturing processes that accomplish the look and feel of natural hide using synthetic materials. For example, materials such as acrylic, modacrylic, polypropylene, rayon, and nylon may be used instead of or in conjunction with the above.

### Adhesives

The adhesives 215 and 225 comprise an adhesive optimized for bonding synthetic fabric materials. In some embodiments adhesives 215 operates to adhere the topmost layer 210 (the tufted layer) of the overall tufted material 200 to the lower layers, and most directly the second material layer 220, and adhesive 225 adheres the second material layer 220 to the third material layer 230. In some embodiments, the selected adhesive material should be flexible and should retain its adhesive properties to keep the tufted material 200 together through rolling and folding and multiple wash and dry cycles. The adhesives 215 and 225 may be a 60 GSM blend comprising thermoplastic styrene-butadiene rubber, mineral oil, petroleum resin, and polyethylene wax. The adhesives 215 or 225 may allow for superior tuft bind performance (based on ISO 4919 standards) and may withstand heat exposure during the production process of the tufted material 200 as well as during post-production processes such as surface applications. The adhesives 215 or 225 function to adhere the layers of the tufted material 200 together through multiple wash and dry cycles.

Although disclosed with specific reference to the blend above, an artisan will recognize from the disclosure herein different or alternative bonding materials and/or manufacturing processes that adhere the first layer to the second layer. For example, materials such as thermoplastic polyurethane adhesive or a polyurethane (PUR) hot melt adhesive comprised of 85-100% isocyanate prepolymer mixed with methylene biphenyl diisocyanate may be used instead of or in junction with the above.

### The Multi-Layer Stack-Tufted Material

The tufted material 200 described above comprises several layers of material bonded together using adhesive that is activated by the application of pressure and heat. Once bonded together, embodiments of the tufted material resist deformation such as shrinkage, curling (including at its corners), warping, and torquing. The tufted material can be produced in large sheets that can then be cut into arbitrary shapes and sizes, including sizes commonly used for rugs, while maintaining washability. For instance, an approximately 5 foot×7 foot (1.524 m×2.1336 m) rectangular rug made of the disclosed tufted material 200 would fit into household washing machines having a capacity of approximately 4.5-5 cubic foot (1.3716 cubic meter×1.524 cubic meter).

Embodiments of the tufted material 200 disclosed herein provide the look and feel of natural wool without including animal byproducts. In particular embodiments, the tufted material 200 may contain minimal or reduced amounts of animal byproducts, as compared to a natural wool material.

The tufted material 200 disclosed herein may avoid downsides of natural wool, such as its tendency to degrade, smell, or even rot over time. The tufted material 200 disclosed herein has a pile height and yarn density that provide a cushioned foot feel. The tufted material 200 may be sufficiently malleable such that it can be folded, rolled, compressed, and go through multiple wash and dry cycles.

In embodiments, the tufted material 200 has a thickness in the range of 9 mm to 10 mm, which provides a pile height while allowing the tufted material 200 to remain amenable to various production processes, such as the application of heat and pressure to bond the layers. In some embodiments, the overall tufted material 200 may be made to have a lower thickness, such as a thickness in the range of 3 mm to 8 mm, by using a shorter pile height for the yarns 211 in the first material layer 210. Available machinery and techniques for applying heat and/or pressure may be limited in the thickness of input materials. The same may be true for available machinery and techniques for applying surface treatment to the tufted material 200, such as color application processes.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. In addition, while reference may be made herein to quantitative measures, values, geometric relationships or the like, unless otherwise stated, any one or more if not all of these may be absolute or approximate to account for acceptable variations that may occur, such as those due to manufacturing or engineering tolerances or the like.

As used herein, a phrase referring to “at least one of” a list of items refers to any combination of those items, including single members. As an example, “at least one of A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y and at least one of Z to each be present.

Various modifications to the implementations described in this disclosure may be readily apparent to those skilled in the art, and the generic principles defined herein may be applied to other implementations without departing from the scope of this disclosure. Thus, the claims are not intended to be limited to the implementations shown herein but are to be accorded the widest scope consistent with this disclosure and the principles and the novel features disclosed herein.

1. A machine-washable tufted material configured to aesthetically appear to be a wool, the tufted material comprising:
a top layer comprising a base material and a plurality of yarns tufted to the base material and treated to be directionalized in an upward direction and having a pile height from 2 mm to 13 mm and a density of 63 GSM to 117 GSM;
a liquid barrier layer; and
a bottom layer.

2. The tufted material of claim 1, further comprising a stabilizing adhesive applied to the base material to maintain stability of the plurality of yarns tufted to the base material.

3. The tufted material of claim 1, wherein the base material of the top layer comprises a non-woven spunlace material.

4. The tufted material of claim 1, wherein the liquid barrier layer comprises polyurethane.

5. The tufted material of claim 1, wherein the base material provides stability to the tufted material.

6. The tufted material of claim 1, wherein the bottom layer comprises an attachment material configured to removably attach to a rug pad.

7. The tufted material of claim 1, wherein the liquid barrier layer is between the top layer and the bottom layer, and wherein a bonding adhesive bonds the layers to one another.

8. The tufted material of claim 1, wherein the plurality of polyester yarns have a pile height within a range of 5 mm to 7 mm.

9. The tufted material of claim 8, wherein the pile height of the plurality of polyester yarns is 6 mm.

10. The tufted material of claim 1, wherein the plurality of polyester yarns have a linear mass density within a range of 1,500 denier to 6,000 denier.

11. The tufted material of claim 10, wherein the density of the plurality of polyester yarns is 3,000 denier.

12. The tufted material of claim 2, wherein the stabilizing adhesive comprises a water-based flame-resistant adhesive that does not contain a hazardous quantity of flame retardant chemicals.

13. The tufted material of claim 12, wherein the stabilizing adhesive comprises a mixture of 55% vinyl acetate ethylene and 45% water.

14. The tufted material of claim 12, wherein the stabilizing adhesive does not deteriorate after undergoing machine washing and drying.

15. The tufted material of claim 1, wherein the tufted material has a thickness within a range of 9 mm to 10 mm.

16. The tufted material of claim 1, wherein the tufted material is configured to be washable in a home washing machine.

17. A washable rug having attributes of a natural wool tufted rug, the washable rug comprising:
a top layer comprising a base material and a plurality of polyester yarns tufted to the base material and treated to be directionalized in a uniform upward direction and having a uniform pile height;
a liquid protection layer; and
an attachment layer.

18. The rug of claim 17, further comprising adhesive.

19. The rug of claim 17, wherein the plurality of polyester yarns have a pile height within a range of 5 mm to 7 mm.

20. The rug of claim 17, wherein the plurality of polyester yarns have a linear mass density within a range of 1,500 denier to 6,000 denier.

21. The rug of claim 17, wherein the rug has a thickness within a range of 9 mm to 10 mm.

22. The rug of claim 17, wherein the rug is configured to be washable in a home washing machine.
